(19) United States
(12) Patent Application Publication
(10) Pub. No.: US 2011/0181402 A1
(43) Pub. Date: Jul. 28, 2011

(54) Novel Tactile Apparatus and Methods

(75) Inventors: Walter Goodrich, Brighton, CO (US); Tyler Todd, Loveland, CO (US); Brett Tatman, Windsor, CO (US)

(73) Assignee: SNAPTRON, INC., Wellington, CO (US)

(21) Appl. No.: 12/863,158

(22) PCT Filed: Jan. 16, 2008
(86) PCT No.: PCT/US2008/051160

§ 371 Date: Jul. 15, 2010

(51) Int. Cl. G08B 6/00

(52) U.S. Cl. 340/407.1

(57) ABSTRACT

Tactile apparatus that, in electrical embodiments, comprises an electrically conductive dome; at least one outer edge portion of the electrically conductive dome that contacts a first electrical contact underlying the dome when the dome is in the electrically closed configuration; and an inner portion of the dome that contacts a second electrical contact underlying the dome when the dome is in the electrically closed configuration, wherein the dome is snap reconfigurable from the electrically open configuration to the electrically closed configuration, and wherein the dome includes a dome height enhancing protrusion at a top thereof. In particular embodiments, the at least one outer edge portion, the inner portion and the dome height enhancing protrusion are made of the same conductive material and/or the dome height enhancing protrusion is a non-interfacially integrated part of the dome. Another aspect of the inventive technology relates more broadly to tactile apparatus that are not limited to merely electrical switch applications.

### I. FIELD OF THE INVENTION

The present inventive technology relates generally to the field of tactile apparatus, including but not limited to tactile electrical switches. Electrical embodiments of the inventive technology relate more particularly to tactile dome switches, which include domes that are snap reconfigurable between an electrically open configuration and an electrically closed configuration, and, typically, underlying electrical contacts. Such switches find extensive use as, e.g., buttons in devices that receive input (whether data or otherwise) from a user. Embodiments of the inventive technology, both electrical and non-electrical, focus on the provision of a dome height enhancing protrusion at the top of the dome, where that dome height enhancing protrusion may be formed at the same time the dome itself is formed, may be a non-interfacially integrated part of the dome, and/or may be of the same material as the rest of the dome, resulting in a simple, easily manufactured design that affords several operational benefits.

### II. BACKGROUND OF THE INVENTION

Tactile apparatus, including but not limited to tactile electrical dome switches are, well known and have been used in various applications for many years. Tactile dome switches, a specific type of tactile apparatus, are a type of electrical switch that may be found in a wide variety of such electrical devices, including, but not limited to: microwave ovens, remote control devices, cell phones, machinery, personal electronic devices (e.g., PDA's), keyboards, SMART cards, and indeed any device that receives touch input. Indeed, their snap response (and often, their accompanying click noise), typically, but not always, in response to a force applied by the tip of a finger, is well known to most people today. Such snap response—whether characterized by a click noise and/or a click, threshold-type feel—is also found in non-electrical tactile apparatus and indeed, is the hallmark of tactile apparatus as defined herein. Non-electrical tactile apparatus include domes that themselves neither complete a circuit nor conduct electricity (although indeed they may be made of conductive material) and include but are not limited to apparatus that (1) notify a surgeon when a particular orientation or configuration of an at least partially obscured cutting instrument has been reached; (2) notify a guitarist that a pedal has been sufficiently depressed to actuate an effect; and (3) notify, without the apparatus itself closing a circuit or conducting electricity, an individual that the electrical configuration of an electrical switch has been changed or may soon change if the individual continues to depress the apparatus (e.g., a dome). As should be understood, the term tactile apparatus refers to an apparatus that, upon application of a downward force (e.g., as applied by the tip of a finger), snap reconfigures from a non-collapsed configuration to a collapsed configuration. Such reconfiguration is often sensible, via tactile feedback, by an individual applying the force; the reconfiguration may indicate to the individual that a change has occurred, a process initiated (e.g., bringing up a website), and/or whether a switch has closed or opened, as but a few examples. However, it should be understood that the term tactile apparatus are not limited to merely those apparatus that are operable with a finger; indeed, particular embodiments may find use in contexts that involve application of the downward force from other than a finger and, indeed, perhaps even other than a human.

Often, as is well known in the tactile apparatus industry, one or more membranes may be placed above the dome for various reasons, including but not limited to dust exclusion, electrical component protection, and appearance. As one can appreciate, in the case of tactile dome switches, such membranes may have the effect of dispersing the switch activation force (e.g., a downward force applied by the finger of a user to close the switch and produce some electrically effected response), thereby resulting in a less pronounced snap or “muffled” snap response, and, possibly switch tease, switch bounce, change in switch sensitivity, reduction of tactile feedback and compromise of the efficacy of the switch process. All such problems are well known to tactile (including membrane) switch engineers. Analogous problems are well known to engineers who focus on non-electrical tactile apparatus. Further, the commonly-used spacer sheet, which has a plurality of holes into which domes may be established in order to maintain proper relative position of the domes during manufacture and use, and underlying backlighting assemblies may, either together or alone, also cause a dispersion of the apparatus activation force (e.g., the force necessary to cause a snap deformation), thereby enhancing the possibility of the aforementioned problems. Reduction of tactile feedback in particular may create user uncertainty as to whether a change has occurred, a process initiated (e.g., bringing up a website), and/or whether a switch has closed or opened. Compensatory user responses to such “muffled” or sub-optimal snap response may be application of a greater than design force, and/or repeated force applications in order to effect a desired change. All the aforementioned problems—and the compensatory use responses—are undesired from a user and manufacturer standpoint.

These problems, however, are not new; indeed, there have been several measures taken in the past to abate or eliminate them. They include: creating larger holes in spacer sheets; establishing down dimples on the underside of a dome switch that might initiate an electrical contact earlier; establishing a raised electrical contact below the dome so that an electrical contact might be initiated earlier; debossing lower surfaces of membranes above the dome center with small diameter bumps to help concentrate the switch activation force onto the center of the dome; establishment of a slug atop the dome, where that slug is of a material that is different from the dome material and epoxied to the top of the dome; and even placement of a single non-conductive layer over domes, where that non-conductive layer is made of a material that is different from the dome material, and features a pronounced bump over the center of the dome (see, JP Pub. No. 2001155586A of JP Pat. App. No. 11336679). Some manufacturers have even placed several identical domes atop one other to abate the aforementioned snap response problems.

However, each of these design measures is not without their drawbacks. Either they require greater manufacturing effort and associated labor and/or material costs, or they have a very limited effect on the problems and result in very limited improvement in apparatus performance.

### III. SUMMARY OF THE INVENTION

An aspect of the inventive technology is a tactile electrical switch apparatus that comprises an electrically conductive dome reconfigurable between an electrically open configuration and an electrically closed configuration; at least one outer edge portion of the electrically conductive dome that contacts a first electrical contact underlying the dome when the dome is in the electrically closed configuration; and an inner portion of the dome that contacts a second electrical contact underlying the dome when the dome is in the electrically closed configuration, wherein the dome is snap reconfigurable from the electrically open configuration to the electrically closed configuration, and wherein the dome includes a dome height enhancing protrusion at a top thereof. In particular embodiments, the at least one outer edge portion, the inner portion and the dome height enhancing protrusion are made of the same conductive material and/or the dome height enhancing protrusion is a non-interfacially integrated part of the dome. As should be understood, the term snap reconfigurable implies that the dome snaps (e.g., exhibits a threshold-type displacement in response to an applied force) upon application of an adequate downward force, and that snaps back upon release of the force. Particular aspects of the inventive technology may relate to a method that, inter alia, comprises the step of simultaneously forming (e.g., via a single stamping) at least one dome and a dome height enhancing protrusion at a top thereof. Aspects of the inventive technology that find application in non-electrical contexts may include novel features that relate to a dome height enhancing protrusion that is a non-interfacially integrated part of the dome, and/or to a dome height enhancing protrusion and a dome remainder that are made of the same material.

It is a goal of at least one electrical embodiment of the inventive technology to provide a tactile electrical switch apparatus that acts to concentrate a switch activation force onto a top thereof, thereby abating aforementioned problems relative to one or more of: reduction in tactile feedback; “muffled” or sub-optimal snap response of a dome switch; compromise of efficacy of the switch process; switch bounce; switch tease; and/or change in switch sensitivity.

It is a goal of at least one electrical embodiment of the inventive technology to provide a tactile electrical switch apparatus that is simple to manufacture and that abates or eliminates aforementioned problems stemming from membranes placed above dome switches and assemblies (e.g., backlighting assemblies and/or spacer sheets) placed below domes.

It is a goal of at least one non-electrical embodiment of the inventive technology to provide a tactile apparatus that acts to concentrate a force onto a top thereof, thereby abating aforementioned problems relative to one or more of: reduction in tactile feedback; “muffled” or sub-optimal snap response of the dome; compromise of efficacy of the dome reconfiguration process; dome bounce; dome tease; and/or change in dome sensitivity.

It is a goal of at least one electrical embodiment of the inventive technology to provide a tactile apparatus that is simple to manufacture and that abates or eliminates aforementioned problems stemming from membranes placed above domes and assemblies (e.g., backlighting assemblies and/or spacer sheets) placed below domes.

It is a goal of at least one embodiment of the inventive technology to provide a tactile apparatus that upon consideration of: (a) its ease of manufacture; and (b) its effectiveness in abating sub-optimal performance problems, may be viewed as an improvement relative to prior designs. Advantages associated with the method include but are not limited to robust manufacturing of domes with dome height enhancing protrusions. Of course, other goals of the various aspects of the inventive technology may appear in the detailed description that follows.

### IV. BRIEF DESCRIPTION OF THE DRAWINGS

FIG. 1A shows a top view of an embodiment of the inventive technology.

FIG. 1B shows a bottom view of an embodiment of the inventive technology.

FIG. 1C shows a side cross-sectional view of an embodiment of the inventive technology.

FIG. 1D shows a perspective view of an embodiment of the inventive technology.

FIG. 1E shows a side view of an embodiment of the inventive technology.

FIG. 2A shows a top view of an embodiment of the inventive technology.

FIG. 2B shows a bottom view of an embodiment of the inventive technology.

FIG. 2C shows a side cross-sectional view of an embodiment of the inventive technology.

FIG. 2D shows a perspective view of an embodiment of the inventive technology.

FIG. 2E shows a side view of an embodiment of the inventive technology.

FIG. 3A shows a top view of an embodiment of the inventive technology.

FIG. 3B shows a bottom view of an embodiment of the inventive technology.

FIG. 3C shows a side cross-sectional view of an embodiment of the inventive technology.

FIG. 3D shows a perspective view of an embodiment of the inventive technology.

FIG. 3E shows a side view of an embodiment of the inventive technology.

FIG. 4A shows a top view of an embodiment of the inventive technology.

FIG. 4B shows a bottom view of an embodiment of the inventive technology.

FIG. 4C shows a side cross-sectional view of an embodiment of the inventive technology.

FIG. 4D shows a perspective view of an embodiment of the inventive technology.

FIG. 4E shows a side view of an embodiment of the inventive technology.

FIG. 5 shows a top view of an embodiment of the inventive technology featuring a truncated leg.

FIG. 6 shows a side view of an embodiment of the inventive technology featuring a truncated leg.

FIG. 7 shows a side view of an embodiment of the inventive technology, with electrical contacts, and featuring a truncated leg.

FIG. 8 shows a top view of an embodiment of the inventive technology.

FIG. 9 shows a side cross-sectional view of an embodiment of the inventive technology, with electrical contacts, in electrically closed configuration.

FIG. 10 shows a perspective view of an embodiment of the inventive technology.

FIG. 11 shows a top transparent view (in order to reveal otherwise hidden electrical contacts) of an embodiment of the inventive technology.

FIG. 12A shows strip stock that may be used in an embodiment of the inventive technology.

FIG. 12B shows formed tactile dome material; more specifically, it shows a strip of formed domes that need to be cut from one another.

FIG. 12C shows formed tactile dome material; more specifically, it shows a strip of single file formed domes that need to be cut from one another

FIG. 13A shows sheet stock.

FIG. 13B shows formed conductive tactile dome material; more specifically, it shows a sheet of formed domes that need to be cut from one another.

FIG. 14 shows tactile dome manufacturing equipment as it may process stock in accordance with an embodiment of the inventive technology.

FIG. 15 shows tactile dome manufacturing equipment as it may process stock in accordance with an embodiment of the inventive technology.

FIG. 16 shows tactile dome switch manufacturing equipment as it may process stock in accordance with an embodiment of the inventive technology.

FIG. 17A shows a top view of an embodiment of the inventive technology.

FIG. 17B shows a bottom view of an embodiment of the inventive technology.

FIG. 17C shows a side cross-sectional view of an embodiment of the inventive technology.

FIG. 17D shows a perspective view of an embodiment of the inventive technology.

FIG. 17E shows a side view of an embodiment of the inventive technology.

### V. DETAILED DESCRIPTION OF THE PREFERRED EMBODIMENTS

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

At least one embodiment of the inventive technology is a tactile electrical switch apparatus 1 that includes an electrically conductive dome 2 (i.e., one that is able to conduct electricity) reconfigurable between an electrically open configuration 3 (type of non-collapsed position) and an electrically closed configuration 4 (type collapsed configuration); at least one outer edge portion 5 of the electrically conductive dome (the bottom of a leg, or lower contacting annulus as but two examples) that contacts a first electrical contact 6 underlying the dome when the dome is in the electrically closed configuration 4; and an inner portion 7 (where inner simply refers to non-edge) of the dome that contacts a second electrical contact 8 underlying the dome when the dome is in the electrically closed configuration. The term snap reconfigurable means that at some point during reconfiguration (change of physical form or shape) of the dome from open 3 to closed electrical configuration 4, the dome snaps such that such snap can be felt and/or heard. Such snap is well known, and may occur at a large displacement per applied force, inter alia. Typically, domes that are snap reconfigurable during reconfiguration from electrically open 3 to electrically closed reconfiguration 4 (upon application of a sufficient switch activation force), and from electrically closed 4 to electrically open configuration 3 (upon disapplication of such force). As such, in preferred embodiments, the dome is snap reconfigurable from the electrically open configuration 3 to the electrically closed configuration 4 (and from the electrically closed configuration 4 to the electrically open configuration 3).

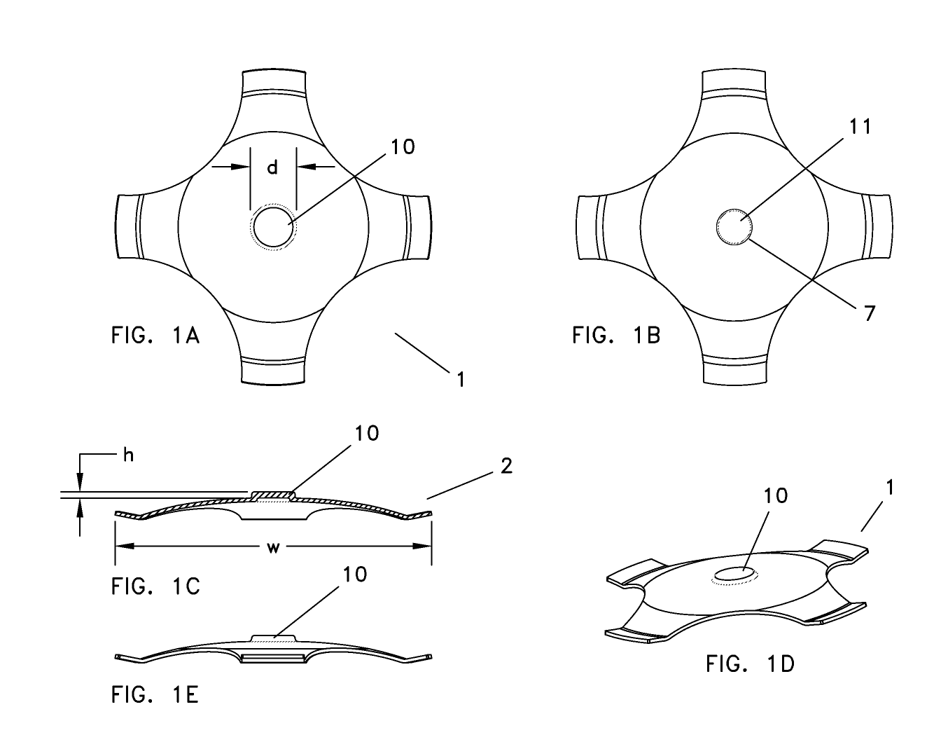

Further, in preferred embodiments, the dome includes a dome height enhancing protrusion 10 at a top thereof. In certain embodiments, the at least one outer edge portion 5, the inner portion 7 and the dome height enhancing protrusion 10 are made of the same conductive material (e.g., steel, such as high grade steel, whether electroplated or not); such characterization applies even where electroplating of the dome material(s) occurs (and if it occurs, regardless of when it occurs in the manufacturing process). In certain embodiments (see, e.g., FIG. 1), the dome height enhancing protrusion 10 is a non-interfacially integrated part of the dome (i.e., it is not a “once discrete” part (e.g., a part that was once freely movable relative to the rest of the dome) that is, e.g., thereafter welded or epoxied onto the top of the rest of the dome, or, generally secured there-against in any fashion, whether an adhesive, epoxy or weld is used or not). As such, non-interfacial integration is, for example, in stark contrast to designs where a once discrete part (e.g., a slug) is secured against the rest of the dome as it merely rests on top of the dome, perhaps substantially held in place relative to the dome by an adjoining membrane or part that covers the entire dome as seen in JP Pub. No. 2001155586A). The term non-interfacially implies the absence of any interface at the base of the dome height enhancing protrusion, where such interface would be mating surfaces (whether they are both flat or not, or adhered together or not) of the bottom of a “once discrete” slug and the top of a dome against which it has been secured. If the dome manufacturing process involves the securement of a once-discrete part in substantially fixed position relative to the rest of the dome, an interface is, by definition, formed where the once discrete part meets the rest of the dome. Such interface exists even where the once-discrete part is of the same material as the rest of the dome against which it is secured.

A preferred manner in which to form a dome having a dome height enhancing protrusion that is a non-interfacially integrated part of the dome is to stamp a substantially single metal material (e.g., sheet or strip stock, which may or may not be electroplated with a different metal) to generate a dome with a dome height enhancing protrusion.

Of course, the term electrically open configuration refers to that physical configuration of the dome that corresponds to no flow of electricity through the circuit while the term electrically closed configuration refers to flow of electricity through the circuit. Further, when a switch activation force is applied to the dome, the dome height enhancing protrusion at the top of the dome effects a concentration of the activation force to the center of the dome, thereby abating or eliminating one or more of the aforementioned sub-optimal snap response problems. The dome height enhancing protrusion may be circular or of other shape when viewed from above, and/or may have a flat upper surface (“mesa-like”) or not. Its profile from the side may show rounded edges and/or pronounced, angular edges, and/or may be curved along its entire profile (e.g., “sunrise” shape).

The dome itself may assume a variety of shapes when viewed from above including but not limited to substantially circular and substantially rectangular. It is of note that a dome having legs and corresponding scalloped recesses between such legs, still may be termed circular or rectangular, as the terms are used to describe the overall, general plan view shape (hence the term substantially). The dome may have a dimpled recess 11 on an underside thereof and substantially under the dome height enhancing protrusion; such recess may be an artifact of the stamping process, as a preferred manufacturing method involves the stamping of metal stock (sheet or strip) that is of uniform thickness. In alternate embodiments, there may be a dimpled protrusion 12 on an underside of the dome and substantially under the dome height enhancing protrusion. This may offer benefits attributable to a comparatively earlier induced electrical contact (and, thus, a quicker circuit closure), which may be desired for certain applications; such a dome may require, e.g., the provision of an appropriately de-bossed (“bumpy”) metal stock from which to form such a dome.

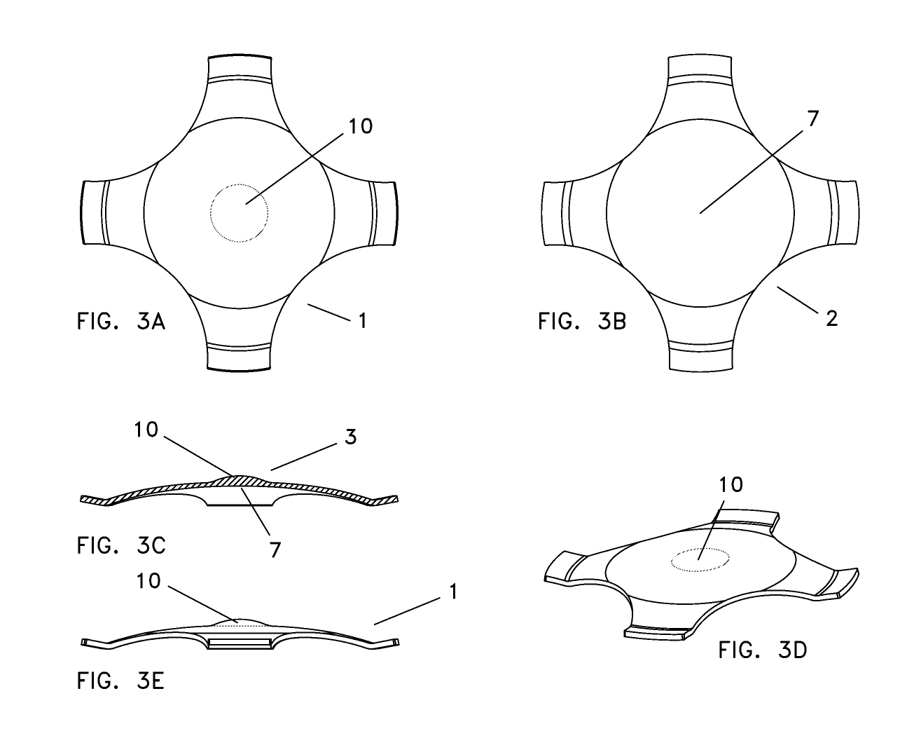

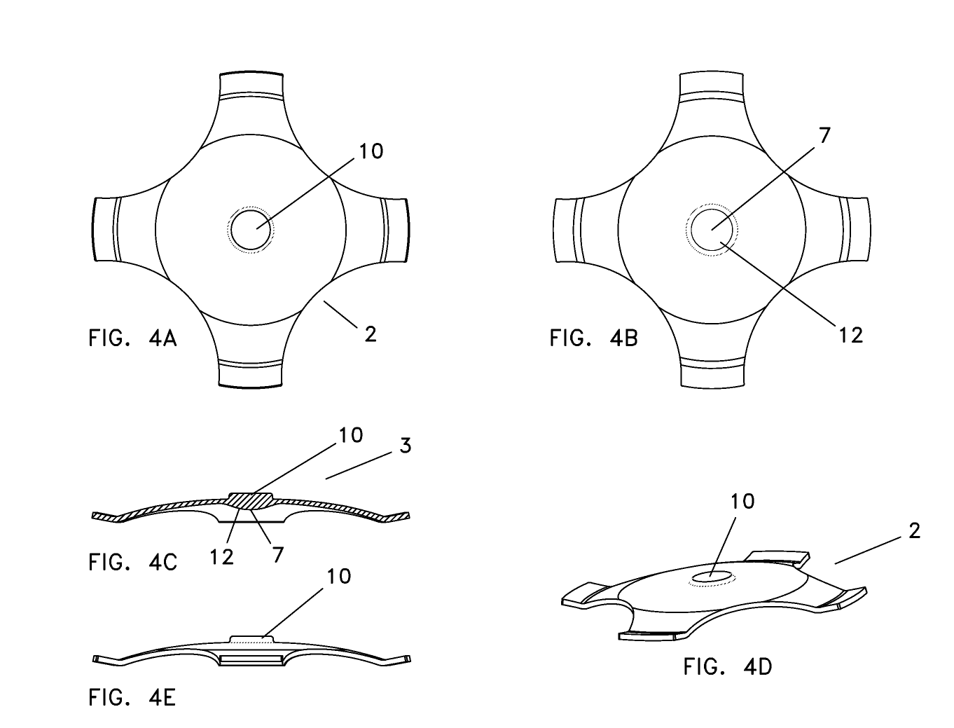

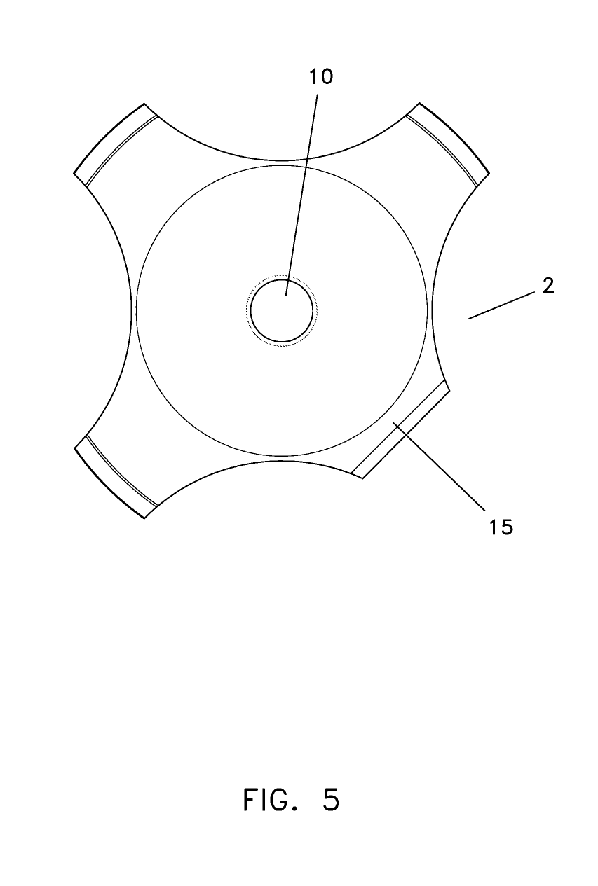

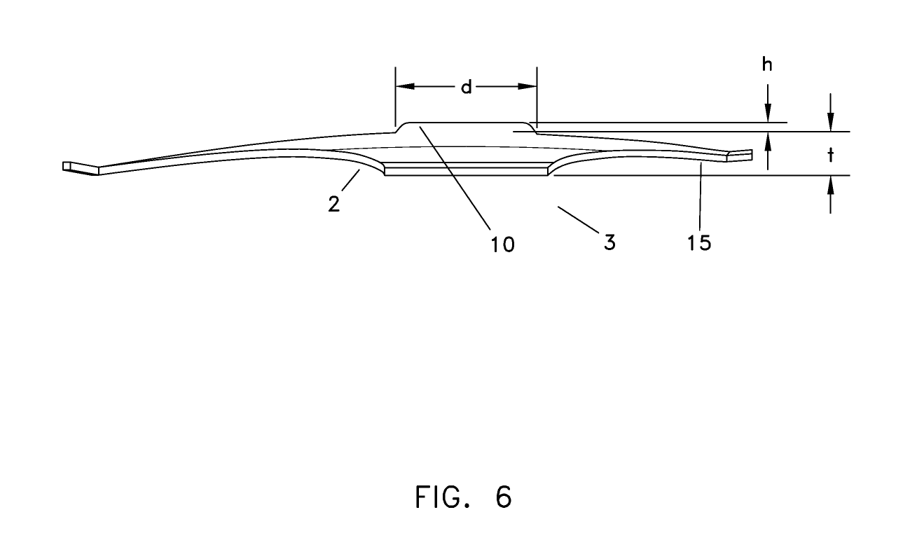

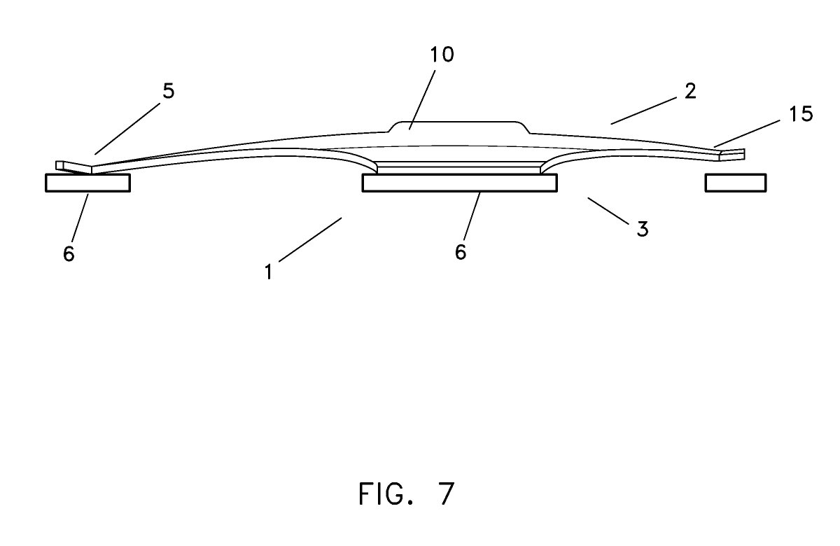

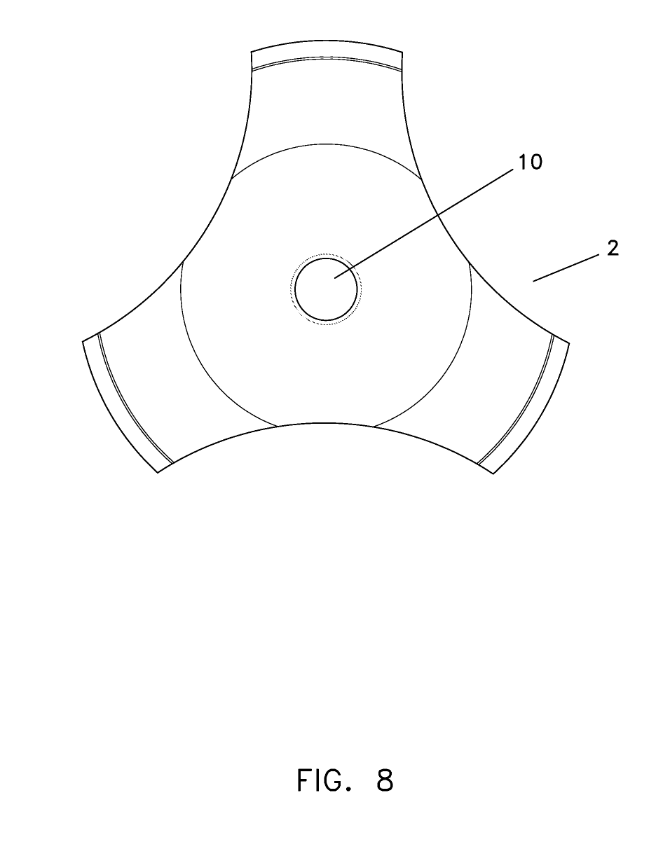

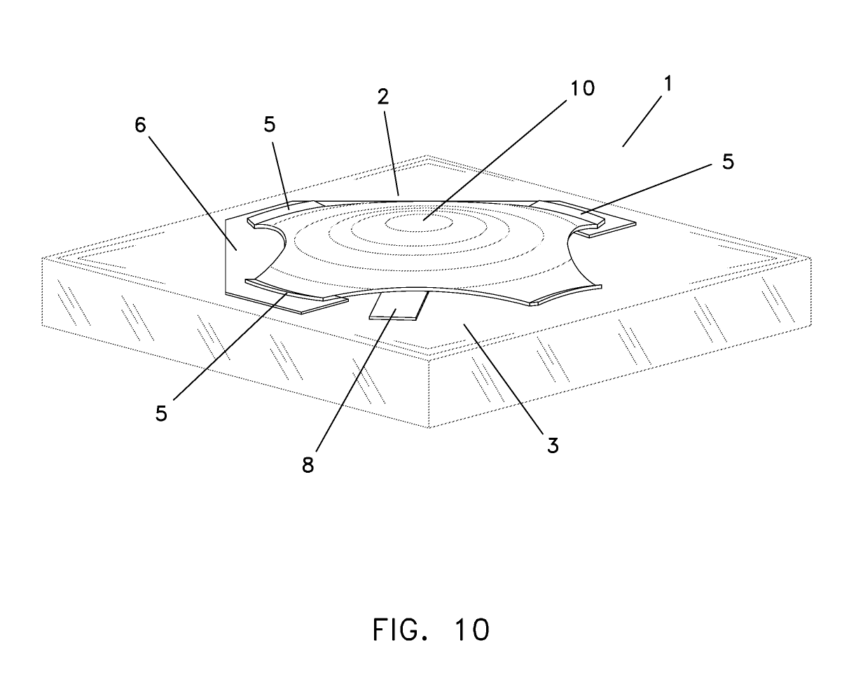

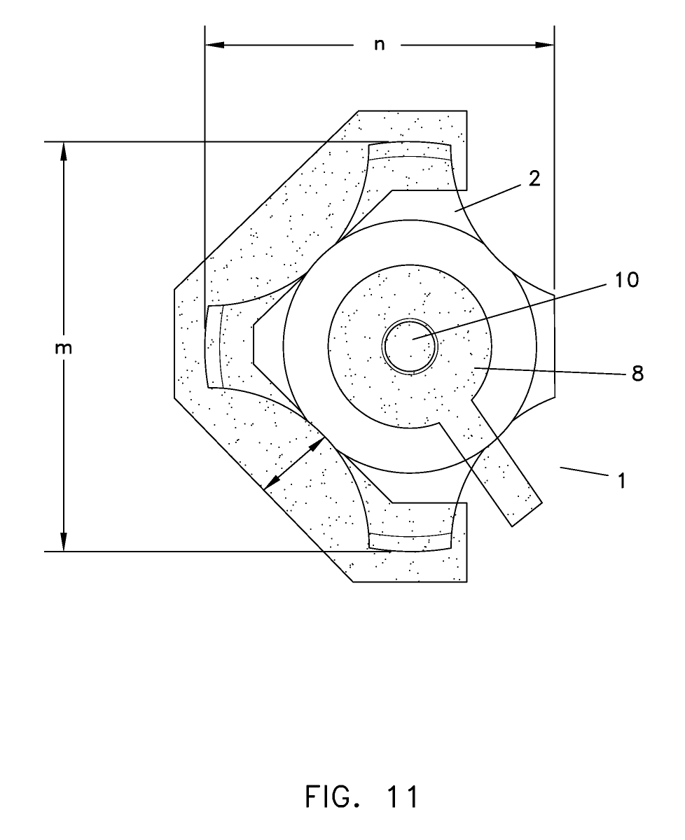

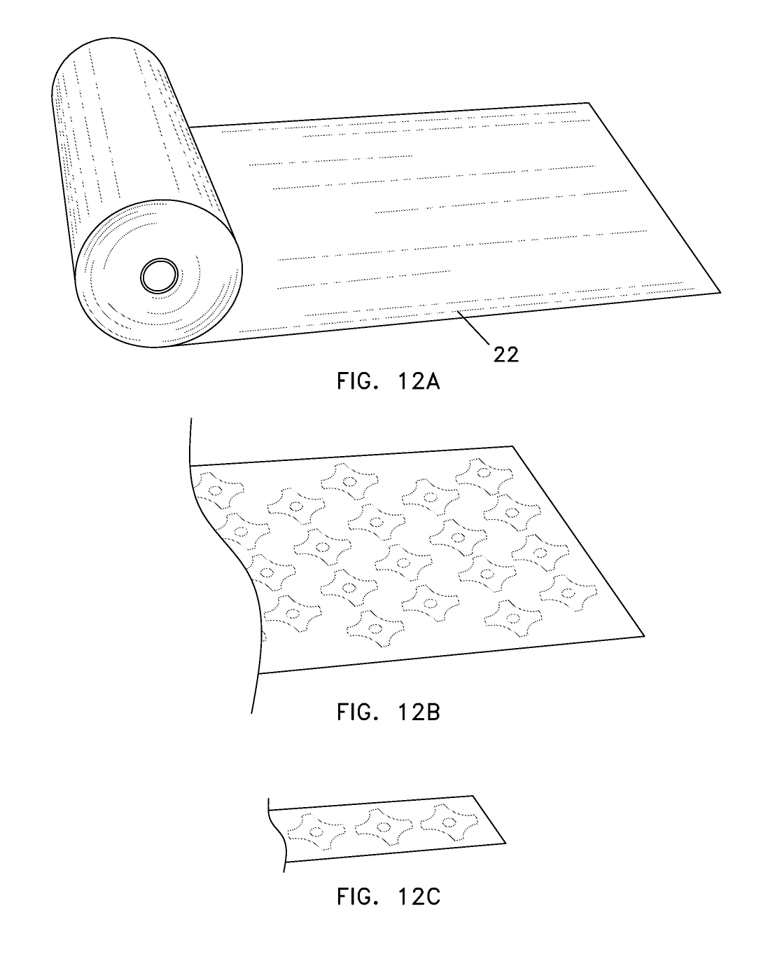

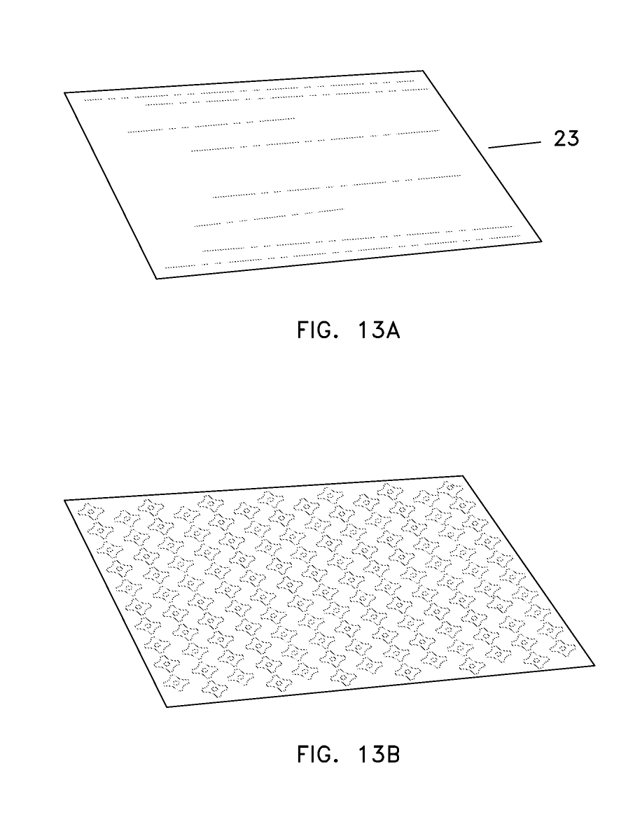

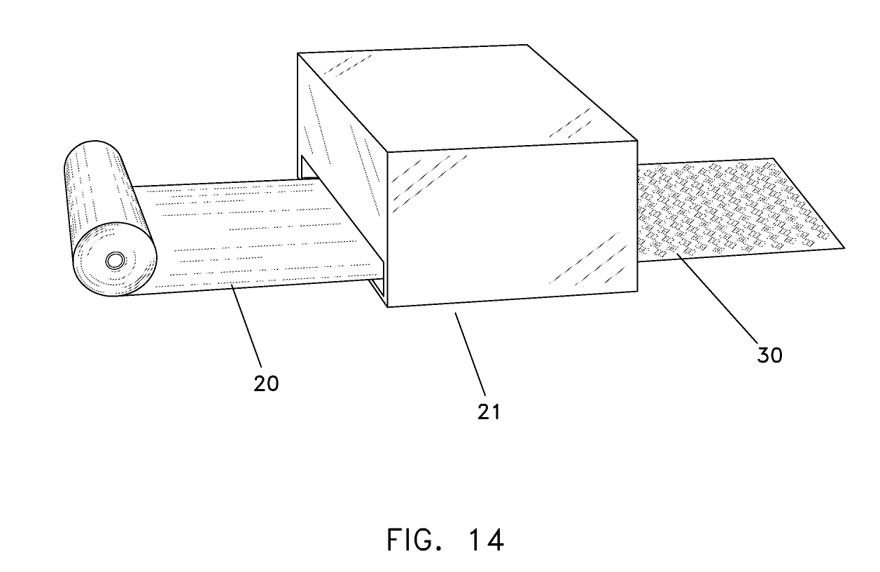

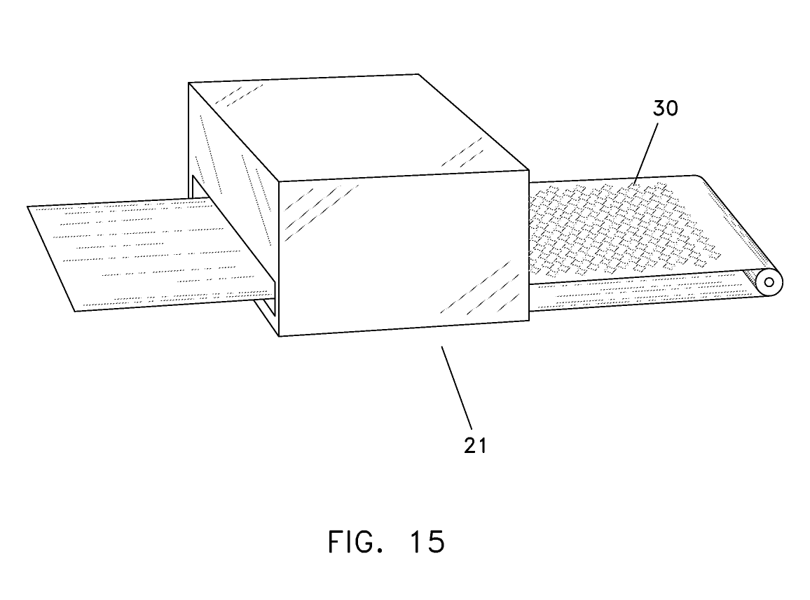

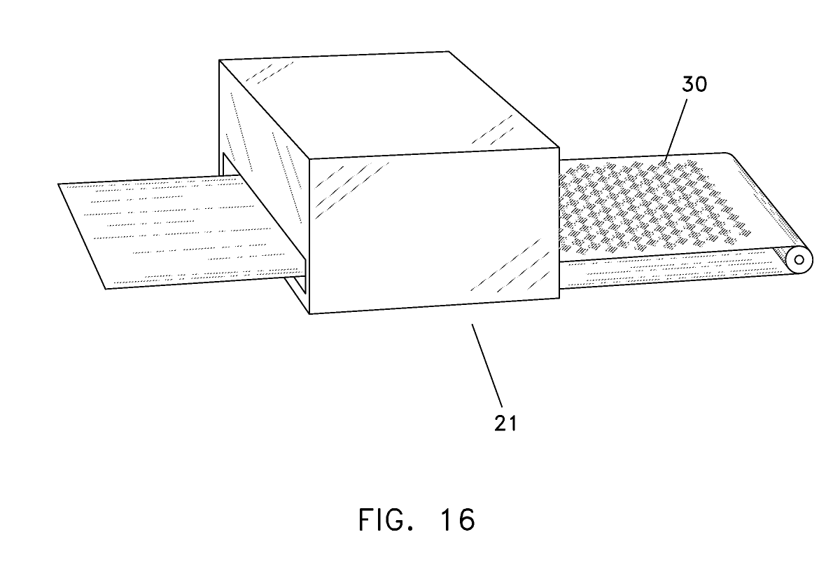

In certain embodiments, the at least one outer edge portion 5 that contacts a first electrical contact 6 underlying the dome 2 when the dome is in the electrically closed configuration 4 is fewer than all outer edge portions that contact an underlying surface when the dome is in the electrically open configuration 3 (see, e.g., FIG. 10). In alternate embodiments, the at least one outer edge portion 5 that contacts a first electrical contact 6 underlying the dome when the dome is in the electrically closed configuration 4 may be all outer edge portions that contact an underlying surface when the dome is in the electrically open configuration. Regardless which design is used, the all outer edge portions may be at least two legs, at least three legs, or four (or even more) legs. One or more of such legs may be truncated 15 as disclosed in U.S. patent application Ser. No. 11/801,630, said application hereby incorporated herein by reference. Indeed, in such embodiments, two sequential electrical contacts may be induced by a single dome upon application of a downward force on the dome by a user. It is also of note that in preferred embodiments, the at least one outer edge portion contacts the first electrical contact when the dome is in the electrically open configuration (as in, e.g., FIGS. 1C, 2C, 3C, 4C, 6, 7 and 10), as well as when the dome is in the electrically closed configuration.

In preferred embodiments, the dome height enhancing protrusion is centrally located (i.e., located at a substantial center of the dome). It may have a variety of shapes, including but not limited to substantially circular, when viewed from above. Also, the dome height enhancing protrusion, in certain embodiments which may yield optimal results, may have a characteristic diameter that is from 20% to 30% the dome diameter w. Even non-circular shaped dome height enhancing protrusions may have a characteristic diameter; it would be 2 (A/π)^{1/2}. Where a dome has legs, the dome diameter may be the diameter of an imaginary circle that is defined by the points of contact of the legs with an underlying surface and by the dome's general shape. For non-circular domes, the dome diameter is a characteristic diameter (an imaginary line may be needed to determine the area under the dome, where that imaginary line would be of a shape defined by the points of contact of any legs with the underlying surface, and by the dome's general shape). In particular embodiments, the dome height enhancing protrusion has a characteristic diameter from 4 to 30 mm; in certain applications, a peak height of the dome height enhancing protrusion may be 0.030″. Exemplary dimensions of the various embodiments of the inventive technology may be as follows:

d=0.09″

w=0.472″

t=0.034″ (+/−0.003″)

h=0.006″

m=0.394″

n=0.325″

Of course, these dimensions are exemplary; their mention does not exclude the many other dimensions which may be used in particular applications.

Particular embodiments may include one or more membranes above the dome and/or a spacer sheet below the dome. The dome conductive material may be any of a variety of materials, including but not limited to steel (e.g., stainless, high grade) or copper; the surface of the dome, whether in its entirety or only partially, may be electroplated, as is well known, in order, for example, to reduce electrical contact resistance or resist corrosion. The electroplating material may be gold, nickel, or silver, as but three of many well known examples.

It is also of note that although the typical application involves the direct application of a switch activation force onto a dome by a human user, certain applications may involve rocker bars, pivoting arms and/or wands that apply the direct force to the top of the dome (even where there are membranes above the dome itself). Such known designs may be see-saw type (e.g., rocker bar design) or pendulum type (e.g., pivot arm type) in nature. Further, any embodiment may involve the use of tape (e.g., clear adhesive tape) to hold domes in their operative position. Particular embodiments may involve the known use of a casing in which a dome may rest and, to a limited extent, move relative thereto.

Particular aspects of the inventive technology may relate to a method that comprises the steps of establishing tactile dome material 20 (e.g., sheet stock 23 or strip stock 22) relative to tactile dome manufacturing equipment 21 (e.g., a punch press and/or a cutter) so that the tactile dome manufacturing equipment may form the tactile dome material as desired (e.g., into one or more domes 30, whether cut from each other or not); and using the tactile dome manufacturing equipment to simultaneously form (e.g., via stamping) from the tactile dome material, at least one dome and a dome height enhancing protrusion at a top thereof. It should be understood that in particular embodiments the stock (typically flat) need not be uni-material (i.e., made from one material), as it may be electroplated, or even have a plastic surface that, when the stock is stamped, may form the dome height enhancing protrusion. However, in preferred electrical switch embodiments, the stock is all metal (whether a first metal such as steel electroplated with a second metal (e.g., gold), or simply one metal entirely). In other, non-electrical embodiments, the stock need not be conductive; indeed materials such as, but not limited to, plastics or fibrous materials (e.g., carbon fiber), may suffice.

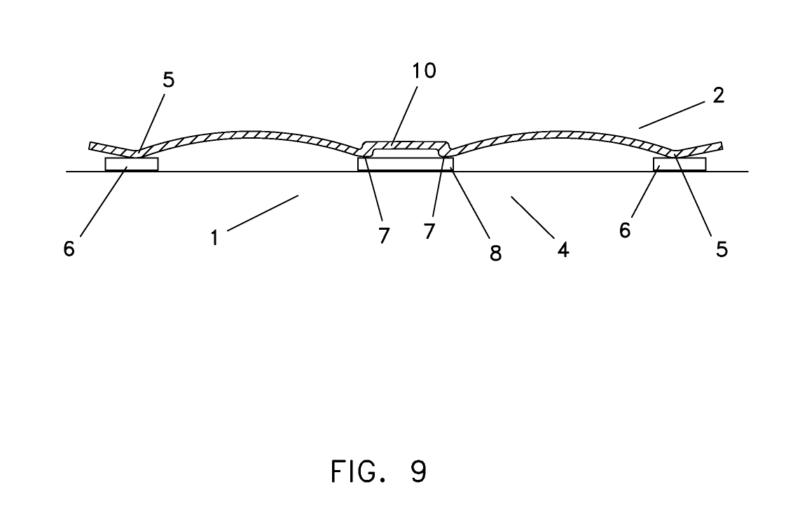

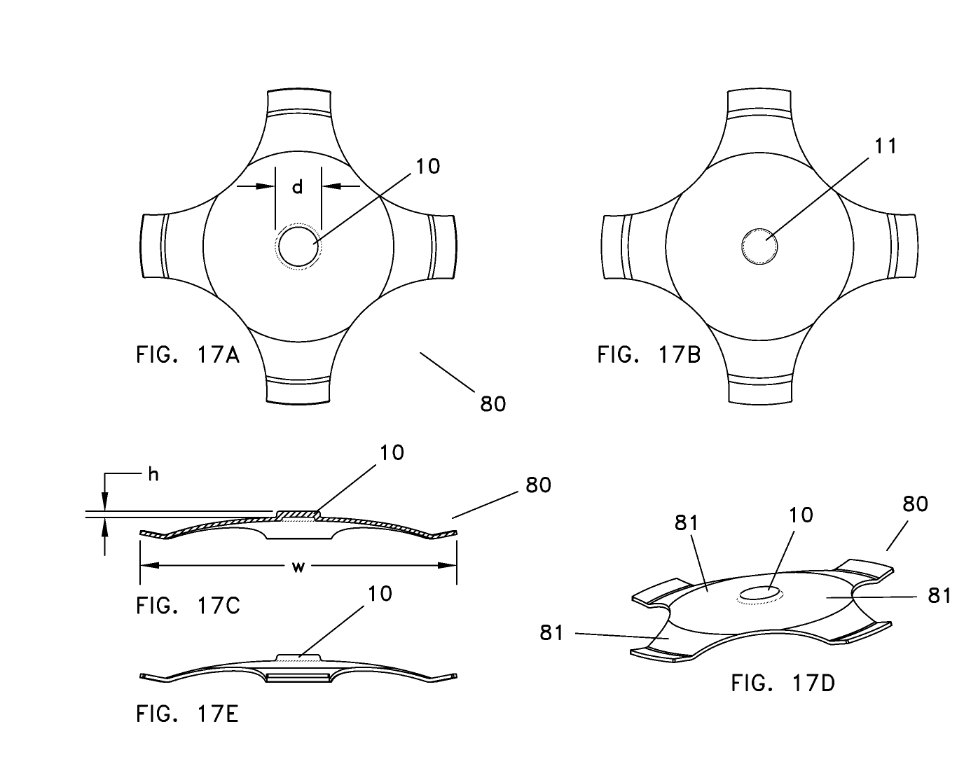

Particular embodiments of the inventive technology may relate to tactile apparatus that comprises a dome 80 reconfigurable between a non-collapsed configuration (see, e.g., FIG. 17) and a collapsed configuration (see, e.g., the dome of FIG. 9); and a dome height enhancing protrusion 10 at a top of the dome, wherein the dome is snap reconfigurable from the non-collapsed configuration to the collapsed configuration, wherein the dome includes the dome height enhancing protrusion 10 and a dome remainder 81 (that portion of the dome other than the dome height enhancing protrusion), and wherein the dome height enhancing protrusion and the dome remainder are made of the same material. In the case of domes that serve as components of electrical switches (electrical application), that same material is conductive (including but not limited to copper, steel, and aluminum, whether electroplated or not); in the case of domes usable in non-electrical applications, that material certainly need not be conductive (although it may be) and includes, but is not limited to plastic, polymeric materials and fibrous materials. In embodiments where the apparatus find use in electrical application (e.g. tactile dome switches), the non-collapsed configuration may be an electrically open configuration and the collapsed configuration is an electrically closed configuration. In certain embodiments, the dome height enhancing protrusion and the dome remainder are formed simultaneously in the same manufacturing step (e.g., a stamping). It is also of note that, in preferred embodiments, the dome height enhancing protrusion is a non-interfacially integrated part of the dome.

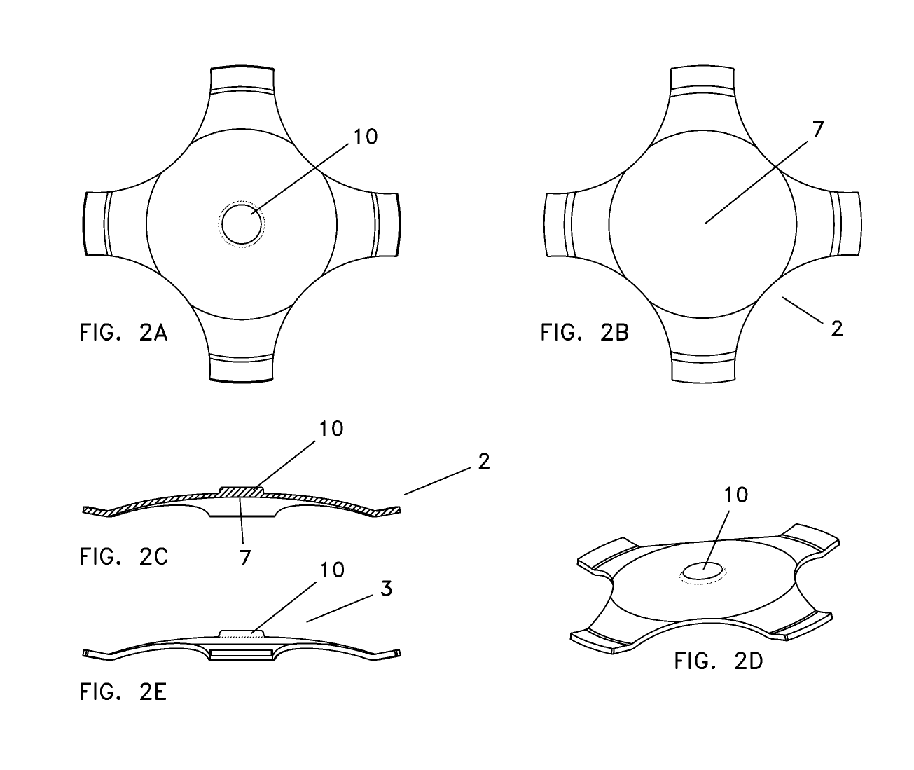

Particular embodiments of the inventive technology may relate to tactile apparatus that comprise a dome 80 reconfigurable between a non-collapsed configuration and a collapsed configuration; and a dome height enhancing protrusion 10 at a top of the dome, wherein the dome is snap reconfigurable from the non-collapsed configuration to the collapsed configuration, wherein the dome includes the dome height enhancing protrusion 10 and a dome remainder 81, and wherein the dome height enhancing protrusion is a non-interfacially integrated part of the dome. As in other embodiments, the dome height enhancing protrusion and the dome remainder may be formed simultaneously in the same manufacturing step (e.g., a stamping); further, the dome height enhancing protrusion and the dome remainder may be made of the same material. Such apparatus be usable in a non-electrical application and/or an electrical application. Of course, certain conductive domes may be used in both. It is of note that apparatus that are not electrically limited in application are by no means limited to those designs shown in FIG. 17, as indeed the domes of FIGS. 2, 3 and 4 also show dome designs that may be suited for non-electrical domes (i.e., domes that find application in non-electrical contexts).

It should be noted that the terms up, down, under, beneath, below, above, etc., as used herein, are not used in a gravitationally based frame of reference (i.e., down does not necessarily mean towards the earth), because tactile switch domes can be used in any orientation. For clarity, the frame of reference used to define such terms has the upwards direction as pointing from a plane defined by the outer edge portions that contact a lower supporting surface when the dome is in an electrically open configuration, up towards the top of the dome. As such, a membrane established “above” (as the term is used in this application) a dome that is in a “gravitationally” upside down orientation (e.g., on the underside of a car roof for use by a driver in controlling, e.g., a car sunroof) would be “gravitationally” below the dome (i.e., closer to the center of the earth than the dome).

As can be easily understood from the foregoing, the basic concepts of the present invention may be embodied in a variety of ways. It involves both tactile switch dome height enhancement techniques as well as devices to accomplish the appropriate tactile switch dome height enhancement. In this application, the tactile switch dome height enhancement techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “protrusion” should be understood to encompass disclosure of the act of “protruding”—whether explicitly discussed or not—and, conversely, were there effectively disclosure of the act of “protruding”, such a disclosure should be understood to encompass disclosure of a “protrusion” and even a “means for protruding” Such changes and alternative terms are to be understood to be explicitly included in the description.

Any acts of law, statutes, regulations, or rules mentioned in this application for patent; or patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Provisional Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

I. U.S. PATENT DOCUMENTS

| DOCUMENT NO. | | PATENTEE OR |
|---|---|---|
| & KIND CODE | PUB'N DATE | APPLICANT |
| (if known) | mm-dd-yyyy | NAME |
| U.S. Pat. No. 3,643,041 | 02/15/1972 | Jackson |
| U.S. Pat. No. 3,886,012 | 05/27/1975 | Slater |
| U.S. Pat. No. 3,908,109 | 09/23/1975 | Studebaker |
| U.S. Pat. No. 4,033,030 | 07/05/1997 | Robinson et al. |
| U.S. Pat. No. 4,153,987 | 05/15/1979 | Boulanger |
| U.S. Pat. No. 4,207,448 | 06/10/1980 | Furusawa et al. |
| U.S. Pat. No. 4,314,117 | 02/02/1982 | Ditzig |
| U.S. Pat. No. 4,349,712 | 09/14/1982 | Michalski |
| U.S. Pat. No. 4,595,809 | 06/17/1986 | Pool |
| U.S. Pat. No. 4,659,881 | 04/21/1987 | Dowe |
| U.S. Pat. No. 5,388,467 | 02/14/1995 | Jereb et al. |
| U.S. Pat. No. 5,451,285 | 9/19/1995 | Santo et al. |
| U.S. Pat. No. 5,510,584 | 04/23/1996 | Morris |
| U.S. Pat. No. 5,564,560 | 10/15/2006 | Minelli, et al. |
| U.S. Pat. No. 5,598,082 | 01/28/1997 | Gilpin et al. |
| U.S. Pat. No. 6,073,341 | 06/13/2000 | Odorfer |
| U.S. Pat. No. 6,133,536 | 10/17/2000 | Hunag et al. |
| U.S. Pat. No. 6,694,605 | 02/24/2004 | Galli |

II. FOREIGN PATENT DOCUMENTS

| Foreign Patent Document | | PATENTEE OR |
|---|---|---|
| Country Code, Number, | PUB'N DATE | APPLICANT |
| Kind Code (if known) | mm-dd-yyyy | NAME |
| WO 00/68964 | 16/11/2000 | Lecourtois |
| WO 96/20799 | 11/07/96 | Lecourtois |
| EP 0 825 913 B1 | 21/11/1996 | Girard, et al. |
| EP 0 800 426 B1 | 11/07/1996 | Lecourtois |
| WO 06/071240 A1 | 7/6/2006 | Snaptron, Inc. |
| WO 96/36457 | 11/21/1996 | Cerm |
| DE 24 48 587 B2 | 04/30/1975 | Chomerics, Inc. |
| JP 2001-155586 | 06/08/2001 | Shin Etsu |
| | | Polymer Co Ltd. |

III. NON-PATENT LITERATURE DOCUMENTS
Assisting our Customers in Reducing Their End Product Costs
Through Mechanization And Automation Of Our Products,
bowman-domes.com/automation.htm; Feb. 9, 2005; 7 pages.
Membrane Switch Tactile Improvement,
Millerdial.com/tactileimprovement, Oct. 24, 2007; 2 pages
Snap Domes, Your Solution Developer, Inovan GmbH & Co KG,
Oct. 24, 2007; 11 pages
U.S. Provisional Application Ser. No. 60/638,917 filed
Dec. 23, 2004 entitled “Efficient Switch Contact
Delivery and Placement Systems”
U.S. Provisional Application, filed Jun. 11, 2007,
entitled “Methods and Apparatus for Performance and
Endurance Testing of Switch Contact Systems”
U.S. Non Provisional Application, Ser. No. 11/801,630,
filed May 9, 2007, entitled “Electrical Switch
Apparatus and Methods”
Search Report and Written Opinion for
PCT/US2005/005873 dated Jul. 22, 2005

Thus, the applicant(s) should be understood to have support to claim and make a statement of invention to at least: i) each of the switch devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. A tactile electrical switch apparatus, comprising:
an electrically conductive dome reconfigurable between an electrically open configuration and an electrically closed configuration;
at least one outer edge portion of said electrically conductive dome that contacts a first electrical contact underlying said dome when said dome is in said electrically closed configuration; and
an inner portion of said dome that contacts a second electrical contact underlying said dome when said dome is in said electrically closed configuration;
wherein said dome is snap reconfigurable from said electrically open configuration to said electrically closed configuration,
wherein said dome includes a dome height enhancing protrusion at a top thereof, and
wherein said at least one outer edge portion, said inner portion and said height enhancing protrusion are made of the same conductive material.

2. A tactile electrical switch apparatus as described in claim 1 wherein said at least one outer edge portion, said inner portion and said dome height enhancing protrusion are formed simultaneously in the same manufacturing step.

3. A tactile electrical switch apparatus as described in claim 2 wherein said at least one outer edge portion, said inner portion and said dome height enhancing protrusion are stamp formed and said same manufacturing step is a stamping.

4. A tactile electrical switch apparatus as described in claim 1 wherein said dome height enhancing protrusion is a non-interfacially integrated part of said dome.

5-7. (canceled)

8. A tactile electrical switch apparatus as described in claim 1 wherein said at least one outer edge portion comprises all outer edge portions that contact an underlying surface when said dome is in said electrically open configuration.

9. A tactile electrical switch apparatus as described in claim 9 wherein said all outer edge portions comprise at least two legs.

10-11. (canceled)

12. A tactile electrical switch apparatus as described in claim 9 wherein at least one of said legs is truncated.

13-17. (canceled)

18. A tactile electrical switch apparatus as described in claim 1 wherein said dome comprises a dimpled recess on an underside of said dome and substantially under said dome height enhancing protrusion.

19. A tactile electrical switch apparatus as described in claim 1 wherein said dome comprises a protrusion on an underside of said dome and substantially under said dome height enhancing protrusion.

20-30. (canceled)

31. A method, comprising the steps of:
establishing tactile dome material relative to tactile dome manufacturing equipment so that said tactile dome manufacturing equipment may form said tactile dome material as desired; and
using said tactile dome manufacturing equipment to simultaneously form, in the same manufacturing step, from said tactile dome material, at least one dome and a dome height enhancing protrusion at a top thereof.

32. A method as described in claim 31 wherein said step of using said tactile dome manufacturing equipment to simultaneously form comprises the step of using a punch press.

33. (canceled)

34. A method as described in claim 31 wherein said at least one dome is snap reconfigurable between a non-collapsed configuration and a collapsed configuration.

35. (canceled)

36. A method as described in claim 31 wherein said at least one dome has two or more legs.

37-69. (canceled)

70. A tactile apparatus, comprising:
a dome reconfigurable between a non-collapsed configuration and a collapsed configuration; and
a dome height enhancing protrusion at a top of said dome,
wherein said dome is snap reconfigurable from said non-collapsed configuration to said collapsed configuration,
wherein said dome includes said dome height enhancing protrusion and a dome remainder, and
wherein said dome height enhancing protrusion and said dome remainder are made of the same material.

71. A tactile apparatus as described in claim 70 wherein said dome height enhancing protrusion and said dome remainder are formed simultaneously in the same manufacturing step.

72. A tactile apparatus as described in claim 71 wherein said dome height enhancing protrusion and said dome remainder are stamp formed and said same manufacturing step is a stamping.

73. A tactile apparatus as described in claim 70 wherein said dome height enhancing protrusion is a non-interfacially integrated part of said dome.

74-75. (canceled)

76. A tactile apparatus as described in claim 70 wherein said dome comprises at least two legs.

77-87. (canceled)

88. A tactile apparatus as described in claim 70 wherein said apparatus is usable in an electrical application.

89. A method as described in claim 70 wherein said non-collapsed configuration is an electrically open configuration and said collapsed configuration is an electrically closed configuration.

90-100. (canceled)

111. A tactile electrical switch apparatus, comprising:
an electrically conductive dome reconfigurable between an electrically open configuration and an electrically closed configuration;
at least one outer edge portion of said electrically conductive dome that contacts a first electrical contact underlying said dome when said dome is in said electrically closed configuration; and
an inner portion of said dome that contacts a second electrical contact underlying said dome when said dome is in said electrically closed configuration,
wherein said dome is snap reconfigurable from said electrically open configuration to said electrically closed configuration,
wherein said dome includes a dome height enhancing protrusion at a top thereof,
wherein said at least one outer edge portion, said inner portion and said height enhancing protrusion are made of the same conductive material,
wherein said at least one outer edge portion, said inner portion and said dome height enhancing protrusion are formed simultaneously in the same stamping step,
wherein said dome height enhancing protrusion is a non-interfacially integrated part of said dome, and
wherein said dome comprises a dimpled recess on an underside of said dome and substantially under said dome height enhancing protrusion.
